(19) United States
(12) Patent Application Publication
(10) Pub. No.: US 2014/0157770 A1
(43) Pub. Date: Jun. 12, 2014

(54) AUXILIARY DEVICE FOR VEHICLE MAINTENANCE

(71) Applicants: Ying-Chieh LIAO, Taichung City (TW); Yu-Kuo Liao, Taichung City (TW)

(72) Inventors: Ying-Chieh LIAO, Taichung City (TW); Yu-Kuo Liao, Taichung City (TW)

(21) Appl. No.: 13/712,921

(22) Filed: Dec. 12, 2012

(51) Int. Cl. B60T 17/22

(52) U.S. Cl. CPC B60T 17/222
USPC 60/584

(57) ABSTRACT

An auxiliary device for vehicle maintenance including a pneumatic cylinder and a multi-mode control vale unit at least having a foot vale is provided. One end of a cylinder body and a first end of an axial rod of the pneumatic cylinder are to be coupled to a steering wheel and a brake pedal, respectively. The foot vale is connected between an inlet and outlet portions and selectively permits the inlet and outlet portions to be communicated pneumatically with each other. When the inlet and outlet portions are communicated pneumatically with each other, pressurized air goes into the cylinder body and drives the axial rod moving away from the cylinder body.

### BACKGROUND OF THE INVENTION

1. Field of the Invention

The present invention relates to an auxiliary device for vehicle maintenance.

2. Description of the Prior Art

Conventionally, a brake fluid can be affected due to various factors, such as that a vehicle is frequently used, or a vehicle carries heavy things so that it has great momentum and therefore requires relatively greater squeezing force for braking. The temperature of the brake fluid is more possible to rise up to its boiling point, and the brake fluid can deteriorate fast. As such, after a vehicle is used for a certain period of time or mileage, the brake fluid has to be changed so as to ensure that the brake system can work normally.

However, it requires generally at least two persons to carry out a brake fluid changing process, in which one carries out the treading on the pedal and releasing the pedal, and the other one have to discharge the brake fluid in the right time so as to avoid the entering of gas into the pipeline of the brake system to disadvantage operation and effect of the brake system.

The present invention is, therefore, arisen to obviate or at least mitigate the above mentioned disadvantages.

### SUMMARY OF THE INVENTION

An object of the present invention is to provide an auxiliary device for vehicle maintenance, through which a brake fluid changing process can be easily completed by a single user. Besides, it can be easily and quickly mounted to or dismounted from a steering wheel and a brake pedal, and expandably applied to various kinds of brake pedals.

To achieve the above and other objects, an auxiliary device for vehicle maintenance includes a pneumatic cylinder and a multi-mode control vale unit. The pneumatic cylinder includes a cylinder body and an axial rod slidably disposed within the cylinder body. A first end of the axial rod extends out of the cylinder body. One end of the cylinder body and the first end are for being mounted respectively to a steering wheel and a brake pedal. The multi-mode control vale unit includes an inlet portion, an outlet portion and a foot vale. The inlet portion is for being communicated with a pressurized air source. The outlet portion is communicated pneumatically with the cylinder body. The foot vale is connected between the inlet portion and the outlet portion and selectively permits the inlet portion and the outlet portion to be communicated pneumatically with each other. When the inlet portion and the outlet portion are communicated pneumatically with each other, the pressurized air goes into the cylinder body and drives the axial rod moving away from the cylinder body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing an auxiliary device for vehicle maintenance in use according to a preferred embodiment of the present invention;

FIG. 2 is a perspective view according to a preferred embodiment of the present invention;

FIG. 2A is a partial breakdown drawing according to a preferred embodiment of the present invention;

FIG. 3 is a side view according to a preferred embodiment of the present invention;

FIG. 4 is a drawing showing a multi-mode control vale unit according to a preferred embodiment of the present invention;

FIG. 5 is a bottom view according to a preferred embodiment of the present invention; and

FIGS. 5A and 5B are partially-enlarged view of FIG. 5.

### DETAILED DESCRIPTION OF THE PREFERRED EMBODIMENTS

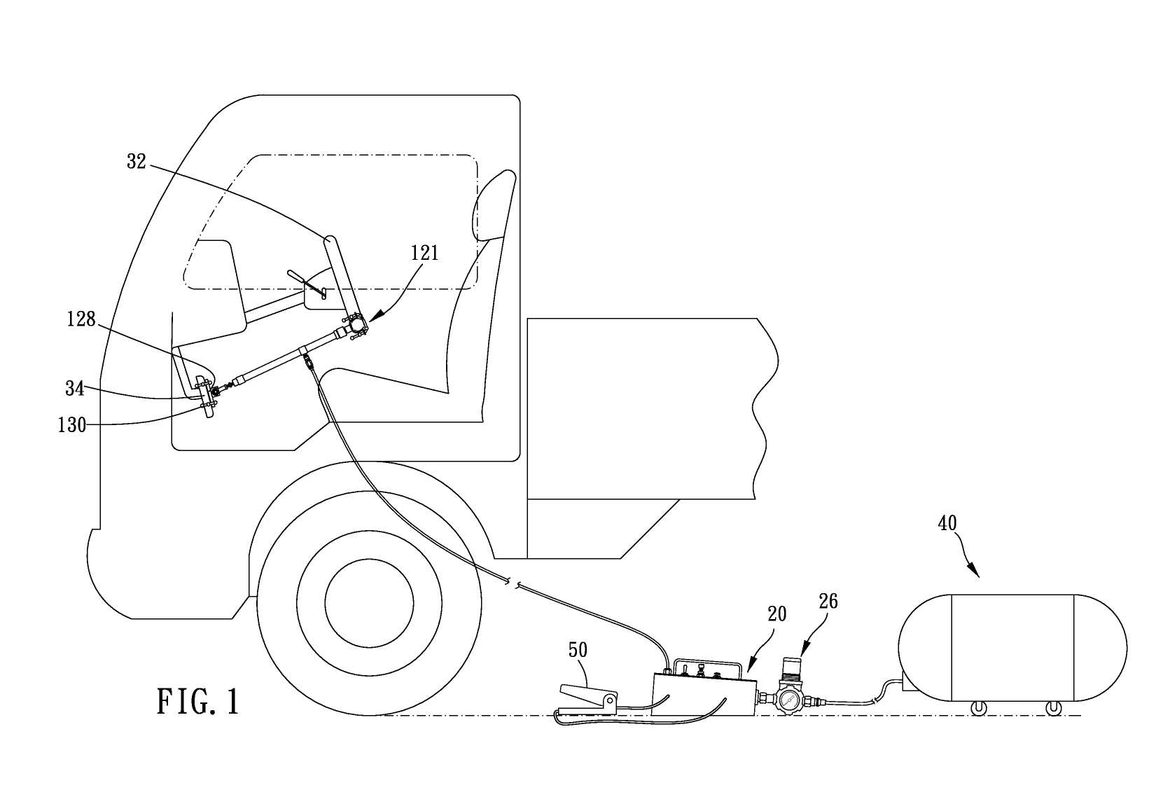

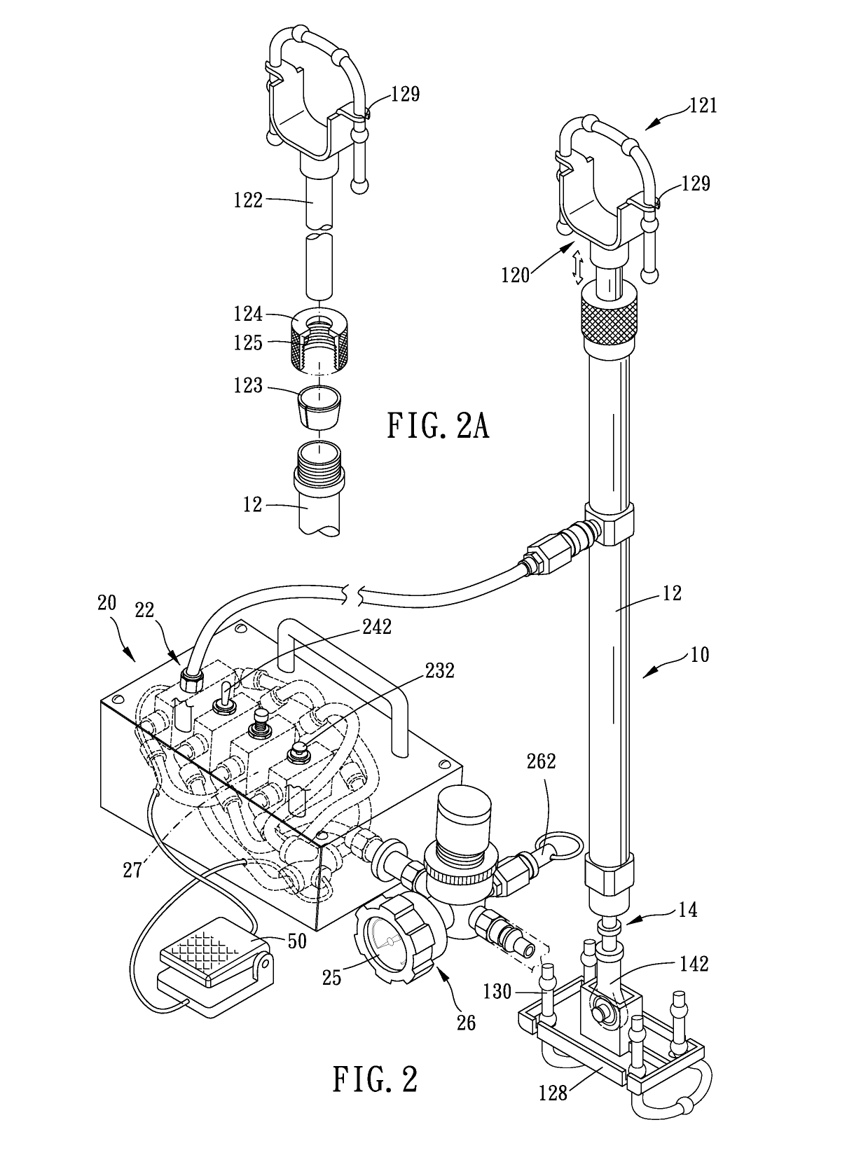

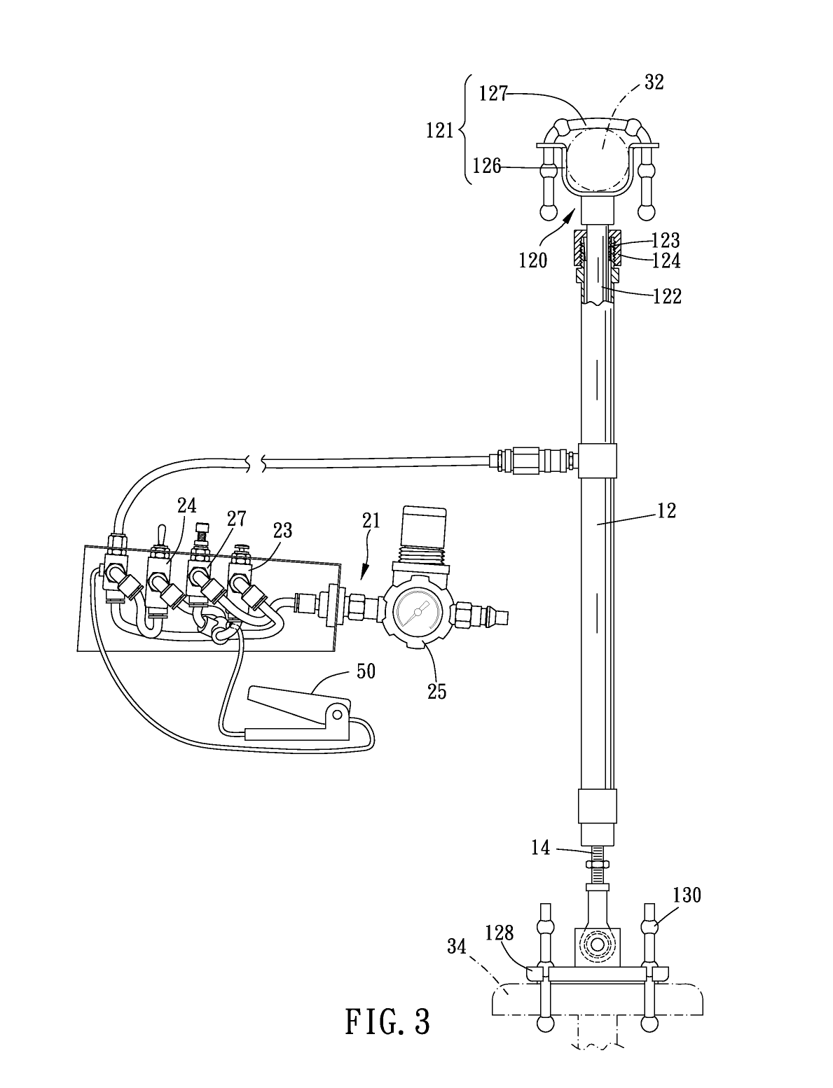

As shown in FIGS. 1, 2, 2A and 3, an auxiliary device for vehicle maintenance according to a preferred embodiment of the present invention includes a pneumatic cylinder 10 and a multi-mode control vale unit 20.

The pneumatic cylinder 10 includes a cylinder body 12, an axial rod 14 slidably disposed within the cylinder body 12 and a piston slidably disposed in the cylinder body 12. A first end 142 of the axial rod 14 extends out of the cylinder body 12, and a second end of the axial rod 14 is connected to the piston. One end of the cylinder body 12 and the first end 142 of the axial rod 14 for being mounted respectively to a steering wheel 32 and a brake pedal 34 of a vehicle (such as a car). More specifically, the other end of the cylinder body 12 is formed with an extension mechanism 120 which is adjustable in length along an axis of the cylinder body 12, and one end of the extension mechanism 120 is formed with a fixation portion 121 which is to be releasably connected to the steering wheel 32.

In this embodiment, the extension mechanism 120 includes a rod body 122, a press member 123 and a ring body 124. One end of the rod body 122 is formed with the fixation portion 121 and the other end thereof is movably disposed within the cylinder body 12. The press member 123 is arranged in the cylinder body 12 and movably disposed around the rod body 122. The ring body 124 is releasably fixed (such as in a screwed manner, but is not limited thereto) to the cylinder body 12 and presses on the press member 123 so that the press member 123 radially inwardly constricts the rod body 122 and is unmovable relative to the rod body 122 and the ring body 124. More specifically, the press member 123 is a generally hollow conical body and radially tapered along a direction toward the cylinder body 12. The hollow conical body is formed with a slot radially on a circumferential surface thereof, and the greatest radial dimension of the hollow conical body is greater than the inner diameter of the cylinder body 12. When the ring body 124 is fixedly connected to the cylinder body 12, the ring body 124 presses and pushes the press member 123 to engage closely with the cylinder body 12. Since the greatest radial dimension of the hollow conical body is greater than the inner diameter of the cylinder body 12 and the slot allows radial deformation of the press member 123, the press member 123 can radially inwardly constrict the rod body 122 so that the rod body 122 is unmovable relative to the cylinder body 12. It is noted that an inner circumferential surface of the ring body 124 may form a generally conical opening 125 which faces the cylinder body 12, the press member 123 may generally correspond to the opening 125 in shape, for example, the press member 123 may be a hollow conical body, and the greatest radial dimension of the hollow conical body is greater than the greatest dimension of the opening 125 and the inner diameter of the cylinder body 12, so that the ring body 124 can gradually radially press the press member 123 harder and harder so as to fasten the rod body 122. As such, the auxiliary device can be adjusted to have a preferred length for operation, and a channel in the cylinder body 12 for movement of the axial rod 14 therein can be shortened so that an entire length of the auxiliary device can be reduced. Preferably, the press member 123 is made of rubber, plastics or the like, which is deformable, so that the press member 123 can tightly be attached to the rod body 122 and the ring body 124.

Preferably, the fixation portion 121 includes an arcuate member 126 and a first fixation member 127. The concave of the arcuate member 126 faces away from the cylinder body 12 and is for receiving the steering wheel 32. At least one of two ends of the first fixation member 127 is releasably and adjustably fixed to the arcuate member 126. Preferably, the first end 142 of the axial rod 14 may be arranged with a generally rectangular plate 128 having a generally rectangular recess for receiving the brake pedal 34. The plate 128 is simple in structure and the recess has a shape corresponding to that of the brake pedal 34, such that it is easy, quick and stable to mount the plate 128 to the brake pedal 34 without slide. The plate 128 is preferably pivoted to the first end 142 of the axial rod 14, so as to ensure that the plate 128 can be perfectly attached to any kinds of brake pedals. Hence, the force provided by the pneumatic cylinder 10 can be effectively imparted onto the brake pedal 34, and during the downward pivot of the brake pedal 34 (the angle, which is relative to a reference plane, of the surface of the brake pedal 34 is changing) the brake pedal 34 is also perfectly attached to the brake pedal 34 without any unexpected displacement. However, the plate 128 may be formed with no recess, or the plate 128 may be not necessary arrangement and the axial rod 14 may be attached to the brake pedal 34. In an alternative embodiment, the plate 128 may be formed with at least one second fixation member 130. At least one of two ends of the second fixation member 130 is releasably and adjustably connected to the plate 128 so as to fasten the plate 128 and the brake pedal 34, so that the plate 128 is unmovable relative to the brake pedal 34.

The multi-mode control vale unit 20 includes an inlet portion 21, an outlet portion 22, a first control vale 23, a second control vale 24 and a foot vale 50. The inlet portion 21 is for a connection with a pressurized air source 40, and the outlet portion 22 and the cylinder body 12 are directly or selectively communicated pneumatically with each other. In this embodiment, the inlet portion 21 is connected to a vale device 26 having a pressure sensor 25, the inlet portion 21 can be selectively communicated pneumatically with the pressurized air source 40 (pressurized air generating device) via the vale device 26, so as to be selectively communicated pneumatically with the pressurized air source 40. Preferably, the vale device 26 further includes a relief portion 262. When the pressure of the pressurized air detected by the pressure sensor 25 is higher than a predetermined pressure, the pressurized air can exhausts via the relief portion 262 to outside so as to ensure the operation pressure is under a safe and suitable condition. Preferably, the relief portion 262 is adjustable, and the predetermined pressure can be adjusted via the relief portion 262.

The first control vale 23 includes a button 232 operable between a first position (as the first control vale 23 is not depressed in this embodiment) and a second position (as the first control vale 23 is depressed in this embodiment). When the button 232 located in the second position is released, the button 232 self-motionally moves to the first position. The second control vale 24 includes a trigger 242 operable between a third position and a fourth position, the trigger 242 is configured to be kept in an orientation without being triggered. For example, when the trigger 242 is moved to the third position or the fourth position, the trigger 242 will stay in the third position or the fourth position unless an external force is imparted onto the trigger 242 to move the trigger 242. The first control vale 23 and the second control vale 24 are connected between the inlet portion 21 and the outlet portion 22 and individually selectively permit the inlet portion 21 and the outlet portion 22 to be communicated pneumatically with each other.

In this embodiment, the first control vale 23 is a “one push-open-close” control vale. More specifically, when the button 232 is depressed to the second position, the first control vale 23 is in an open status and can permits the inlet portion 21 and the outlet portion 22 to be communicated pneumatically with each other; when the button 232 is released, the button 232 self-motionally moves to the first position, and the first control vale 23 is in a closed status and does not permit the inlet portion 21 and the outlet portion 22 to be communicated pneumatically with each other. The second control vale 24 is a switch type control vale or the like. More specifically, when the trigger 242 is switched to the fourth position, the second control vale 24 is in an open status and can permits the inlet portion 21 and the outlet portion 22 to be communicated pneumatically with each other; when the trigger 242 is switched to the third position, the second control vale 24 is in a closed status and does not permit the inlet portion 21 and the outlet portion 22 to be communicated pneumatically with each other.

More specifically, when the button 232 is located in the first position, the inlet portion 21 and the outlet portion 22 are uncommunicated pneumatically with each other; when the button 232 is located in the second position, the inlet portion 21 and the outlet portion 22 are communicated pneumatically with each other so that the pressurized air goes into the cylinder body 12 and drives the axial rod 14 moving away from the cylinder body 12 so that the axial rod 14 depresses the brake pedal 34. When the trigger 242 is located in the third position, the inlet portion 21 and the outlet portion 22 are uncommunicated pneumatically with each other, when the trigger 242 is located in the fourth position, the inlet portion 21 and the outlet portion 22 are communicated pneumatically with each other so that the pressurized air goes into the cylinder body 12 and drives the axial rod 14 moving away from the cylinder body 12 so that the axial rod 14 depresses the brake pedal 34.

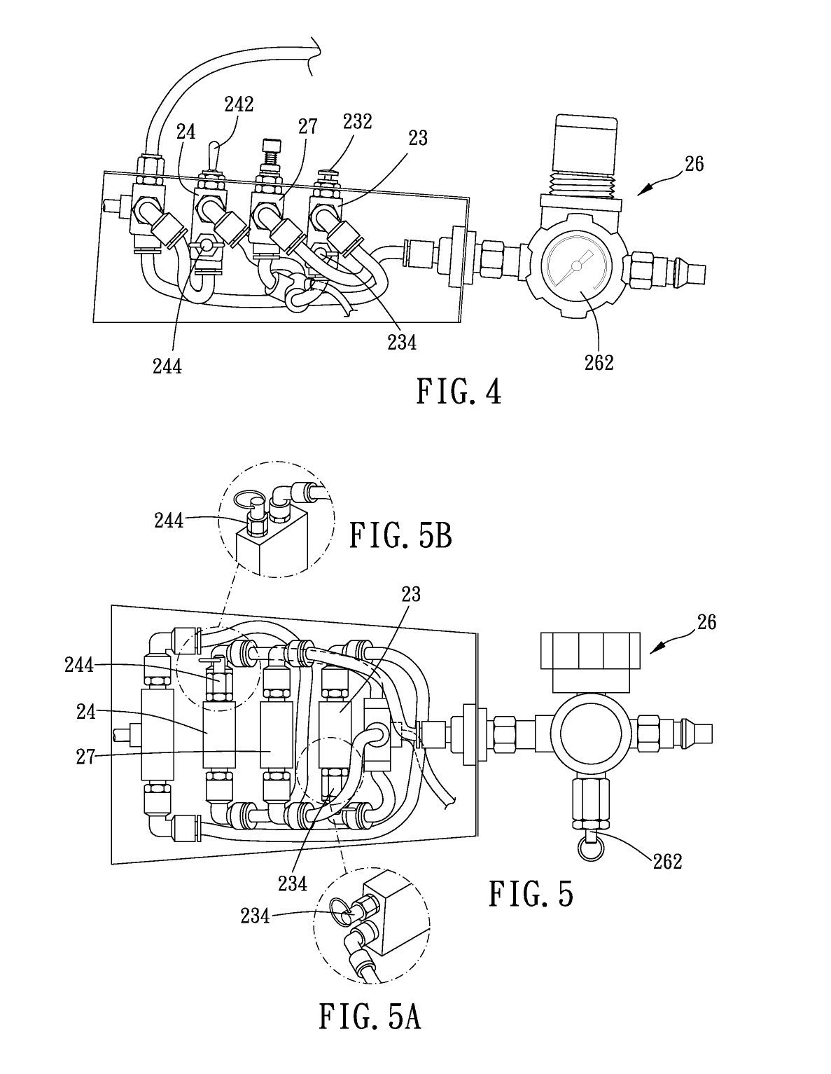

As shown in FIGS. 4, 5, 5A and 5B, preferably, at least one of the first control vale 23 and the second control vale 24 includes a relief mechanism. In this embodiment, the first control vale 23 and the second control vale 24 include relief mechanisms 234, 244, which can exhaust the pressurized air outside when the pressure of the pressurized air is unsuitably high, so as to ensure that the operation pressure is under a safe and suitable condition.

The foot vale 50 is connected between the inlet portion 21 and the outlet portion 22 and selectively permits the inlet portion 21 and the outlet portion 22 to be communicated pneumatically with each other. For example, when the foot vale 50 is not depressed, the foot vale 50 is in a closed status and the inlet portion 21 and the outlet portion 22 are uncommunicated pneumatically with each other; when the foot vale 50 is depressed, the foot vale 50 is in an open status and can permits the inlet portion 21 and the outlet portion 22 to be communicated pneumatically with each other.

In this embodiment, the multi-mode control vale unit 20 further includes a multiport valve 27 through which the inlet portion 21 is communicated with the first control vale 23 and the second control vale 24. Through the multiport valve 27 the pressurized air can be separated to flow to the first control vale 23 and the second control vale 24. Preferably, the multiport valve 27 can be selectively opened or closed, so as to selectively permit the inlet portion 21 to be communicated pneumatically with the first control vale 23 and the second control vale 24. It is noted that the multiport valve 27 may be provided with a relief mechanism for exhausting the pressurized air outside in good time, thus ensuring that the operation pressure is under a safe and suitable condition. Additionally, the multi-mode control vale unit 20 may be provided with hand grip for easy use.

It is noted that hoses, in this embodiment, are adopted for any connections among the inlet portion 21, the outlet portion 22, the first control vale 23, the a second control vale 24, the multiport valve 27, the pressurized air source 40 and the foot vale 50; however, any member which can establish a pneumatic communication among parts may be applied.

In a brake fluid changing process, an user in advance mounts the plate 128 onto the brake pedal 34, and then fixes the plate 128 to the brake pedal 34 via the second fixation member 130.

The ring body 124 is loosen, and the rod body 122 is adjusted to extend out of the cylinder body 12 by an operation distance according a distance between the steering wheel 32 and brake pedal 34. The ring body 124 is then fastened to fix to the cylinder body 12 so that the press member 123 presses the rod body 122, and whereby the auxiliary device therefore has a suitable length for operation. The arcuate member 126 is supported under the steering wheel 32 and the first fixation member 127 is disposed around the steering wheel 32. One end of the first fixation member 127 is fixed to one end of the arcuate member 126, and the first fixation member 127 is laterally fixed into a slit 129 at the other end of the arcuate member 126. Whereby, the fixation portion 121 can be fixed to any kinds or/and sizes of steering wheels, and it is easy to operate. It is noted that the procedure of mounting the plate 128 to the brake pedal 34 and the procedure of adjusting the protrusive length of the rod body 122 out of the cylinder body 12 can be interchangeable.

In a brake fluid changing process, the user generally stands near a drain port for the brake fluid. Accordingly, the foot vale 50 is preferably located nearby the user, thus facilitating the user to tread and control the foot vale 50, to permit or unpermit the inlet portion 21 and the outlet portion 22 to be communicated or uncommunicated pneumatically with each other. As such, two hands of the user are still free to carry out other procedures at the same time. Through repeatedly treading and releasing the foot vale 50, the inlet portion 21 and the outlet portion 22 are communicated pneumatically with each other for several times, in which each time the pressurized air goes into the cylinder body 12 to drive the axial rod 14 moving away from the cylinder body 12 to depress the brake pedal 34. When the pressure of a brake system reaches to a predetermined level, the user can keep the foot vale 50 depressed so that the inlet portion 21 and the outlet portion 22 are communicated pneumatically with each other, and the pressurized air keeps driving the axial rod 14 moving away from the cylinder body 12 to depress the brake pedal 34; in the meanwhile, the pressure in the brake system is of a fixed pressure value, and the drain port is then opened to allow the brake fluid to discharge outside. As the above procedures are repeated several times, the brake fluid brake fluid changing process is completed.

It is noted that the brake fluid brake fluid changing process can be completed in the following processes. Through pushing the button 232 for several times, the button 232 moves between the first and second position there and back, that is, the inlet portion 21 and the outlet portion 22 are communicated pneumatically with each other for several times, in which each time the pressurized air goes into the cylinder body 12 to drive the axial rod 14 moving away from the cylinder body 12 to depress the brake pedal 34. When the pressure of a brake system reaches to a predetermined level, the trigger 242 is then switched to the fourth position so that the inlet portion 21 and the outlet portion 22 are communicated pneumatically with each other so that the axial rod 14 keeps depressing the brake pedal 34. As the above procedures are repeated several times, the brake fluid brake fluid changing process is completed.

Through the above structure, the brake fluid changing process can be easily completed by a single user without shortcomings of requirement of at least two persons to carry out a brake fluid changing process in the prior art.

Furthermore, the auxiliary device may include the extension mechanism 120 which is adjustable to extend out of the cylinder body 12 by an operation distance according a distance between the steering wheel 32 and brake pedal 34, and thus it can be easily and quickly mounted or dismounted.

Moreover, the plate 128 having a recess may be pivoted to the axial rod 14 of the auxiliary device, so that it is easy, quick and stable to mount the plate 128 to the brake pedal 34 without any slide, and expandably applied to various kinds of brake pedals.

It is noted that the auxiliary device of the present invention is not limited to the brake fluid changing process, and may be applied to other maintenance process, such as fluid pressure detection or the like, demanding requirement of depressing a brake pedal.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An auxiliary device for vehicle maintenance, including:
a pneumatic cylinder, including a cylinder body and an axial rod slidably disposed within the cylinder body, a first end of the axial rod extending out of the cylinder body, one end of the cylinder body and the first end for being mounted respectively to a steering wheel and a brake pedal; and
a multi-mode control vale unit, including an inlet portion, an outlet portion and a foot vale, the inlet portion for being communicated with a pressurized air source, the outlet portion communicated pneumatically with the cylinder body, the foot vale connected between the inlet portion and the outlet portion and selectively permitting the inlet portion and the outlet portion to be communicated pneumatically with each other, when the inlet portion and the outlet portion are communicated pneumatically with each other, the pressurized air goes into the cylinder body and drives the axial rod moving away from the cylinder body.

2. The auxiliary device for vehicle maintenance of claim 1, wherein the other end of the cylinder body is formed with an extension mechanism which is adjustable in length along an axis of the cylinder body, and one end of the extension mechanism is formed with a fixation portion which is to be releasably connected to the steering wheel.

3. The auxiliary device for vehicle maintenance of claim 2, wherein the extension mechanism includes a rod body, a press member and a ring body, one end of the rod body is formed with the fixation portion and the other end thereof is movably disposed within the cylinder body, the press member is arranged in the cylinder body and movably disposed around the rod body, the ring body is releasably fixed to the cylinder body and presses on the press member so that the press member constricts the rod body and is unmovable relative to the rod body and the ring body.

4. The auxiliary device for vehicle maintenance of claim 1, wherein the multi-mode control vale unit further includes a first control vale and a second control vale, the first control vale includes a button operable between a first position and a second position, when the button located in the second position is released, the button self-motionally moves to the first position, the second control vale includes a trigger operable between a third position and a fourth position, the trigger is configured to be kept in an orientation without being triggered, the first control vale and the second control vale are connected between the inlet portion and the outlet portion and individually selectively permits the inlet portion and the outlet portion to be communicated pneumatically with each other;
wherein when the button is located in the first position, the inlet portion and the outlet portion are uncommunicated pneumatically with each other, when the button is located in the second position, the inlet portion and the outlet portion are communicated pneumatically with each other so that the pressurized air goes into the cylinder body and drives the axial rod moving away from the cylinder body; when the trigger is located in the third position, the inlet portion and the outlet portion are uncommunicated pneumatically with each other, when the trigger is located in the fourth position, the inlet portion and the outlet portion are communicated pneumatically with each other so that the pressurized air goes into the cylinder body and drives the axial rod moving away from the cylinder body.

5. The auxiliary device for vehicle maintenance of claim 2, wherein the fixation portion includes an arcuate member and a first fixation member, the arcuate member is for receiving the steering wheel, and at least one of two ends of the first fixation member is releasably and adjustably fixed to the arcuate member.

6. The auxiliary device for vehicle maintenance of claim 3, wherein the fixation portion includes an arcuate member and a first fixation member, the arcuate member is for receiving the steering wheel, and at least one of two ends of the first fixation member is releasably and adjustably fixed to the arcuate member.

7. The auxiliary device for vehicle maintenance of claim 1, wherein a plate which is for attaching to the brake pedal is disposed at the first end of the axial rod.

8. The auxiliary device for vehicle maintenance of claim 7, wherein the plate is pivoted to the first end of the axial rod.

9. The auxiliary device for vehicle maintenance of claim 7, wherein the plate is formed with at least one second fixation member, and at least one of two ends of the second fixation member is releasably and adjustably connected to the plate to fasten the plate and the brake pedal.

10. The auxiliary device for vehicle maintenance of claim 1, wherein the inlet portion is connected to a vale device including a pressure sensor.

11. The auxiliary device for vehicle maintenance of claim 10, wherein the vale device further includes a relief portion.
